(19) United States
(12) Patent Application Publication
(10) Pub. No.: US 2006/0109502 A1
(43) Pub. Date: May 25, 2006

(54) Image print instruction apparatus, control method of the same, and image printing system

(75) Inventors: Yasumasa Nakajima, Nagano-ken (JP); Kazunori Suenaga, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/185,969

(22) Filed: Jul. 21, 2005

(30) Foreign Application Priority Data
Jul. 21, 2004 (JP) 2004-213220
Jul. 15, 2005 (JP) 2005-206737

(51) Int. Cl. G06F 3/12

(52) U.S. Cl. 358/1.15; 358/1.2

(57) ABSTRACT

When settings including an arrangement of images in respective image frames on a selected template have been provided and printing has been instructed (S100 to S120), model information is obtained from a printer to judge a storage capacity of a work memory of the printer (S130 and S140), the amount of allocation of the work memory to the images arranged in the respective image frames is judged and resizing of the respective images based on this amount of allocation and an image rotation are carried out (S150 and S160), and resized images are written in a storage medium and print layout information is transmitted to the printer (S170 to S200) . As a result, the total amount of data volumes of the respective images to be transmitted to the printer can be made within the storage capacity of the work memory, thus processing efficiency of various image processes at the printer side can be improved.

### BACKGROUND OF THE INVENTION

1. Field of the Invention

The present invention relates to an image print instruction apparatus, a control method of the same, and an image printing system, and in particular, to an image print instruction apparatus for instructing a communicable printer to print images, a control method of the same, and an image printing system provided with such a printer and an image print instruction apparatus for instructing this printer to print images.

2. Description of the Prior Art

Priorly, as an image print instruction apparatus of this type, a digital camera for directly outputting a photographed image to an external device such as a printer or the like has been proposed (see Japanese Patent Laid-Open Gazzete No. 2001-136432, for example). In this digital camera, by setting a printer resolution and a print size when printing as well as by resizing and recording an image photographed according to contents of this setting in advance, it is made unnecessary to perform image resizing when printing.

### SUMMARY OF THE INVENTION

In the above-described digital camera, although it is possible to resize and record an image according to a setting when printing in advance, when a variety of settings are possible when setting (in such a case where a desirable layout can be selected from a plurality of print layouts) , it is difficult to correspond to the same. In addition, even if an image is resized according to a printer resolution and a print size, a decline in processing speed sometimes occurs when, for example, carrying out various image processes for printing at the printer side. For example, when the capacity of a working memory of a printer used for various image processes is not sufficient, since the whole of an image outputted from the digital camera cannot be stored, various image processes are to be repeatedly executed while reading-in a part of the image, thus processing efficiency is lowered. In particular, when communication speed is slow between the digital camera and printer, the process for reading-in a part of the image becomes bottlenecked and causes an increase in time required for printing.

It is an object of an image print instruction apparatus, a control method of the same, and a program and image printing system used for the same of the present invention to more appropriately instruct a printer to print images according to capacity of a working memory of the same. Also, it is an object of an image print instruction apparatus, a control method of the same, and a program and image printing system used for the same of the present invention to improve processing efficiency of various image processes at the printer side.

At least part of the above and the other related objects is attained by an image print instruction apparatus, a control method of the same, a program used for the image print instruction apparatus, and an image printing system of the present invention having the configurations discussed below.

The present invention is directed to an image print instruction apparatus for instructing a communicable printer to print images. The image print instruction apparatus includes: an information storage unit for storing images; a storage capacity obtaining module for obtaining a storage capacity of a working storage unit possessed by the printer; a print layout setting module for setting a print layout by arranging at least one of the images stored in the information storage unit; an image resizing module for resizing images so that a total amount of data volumes of respective images arranged on the print layout becomes within a predetermined data volume on the basis of the storage capacity of the working storage unit; and a print instructing module for instructing the printer to print the resized images according to the print layout.

In this image print instruction apparatus of the present invention, a storage capacity of the working storage unit of the printer is obtained, while respective images are resized so that a total 4amount of data volumes of the respective images arranged on a print layout becomes within a predetermined data volume on the basis of the storage capacity of the working storage unit, and the printer is instructed to print the resized images. Accordingly, the total amount of data volumes of the respective images to be transmitted to the printer can be made within the predetermined data volume on the basis of the storage capacity of the working storage unit of the printer. As a result, image printing can be more appropriately instructed according to the storage capacity of the working storage unit of the printer while processing efficiency of various image processes at the printer side can be improved. Herein, the “image print instruction apparatus” may be a digital camera.

In such an image print instruction apparatus of the present invention, it is also possible that the information storage unit stores types of printers and storage capacities of working storage units possessed by the printers in a correlated manner, and the storage capacity obtaining module obtains, from the printer, the type of printer and obtains, from the information storage unit, a storage capacity of a working storage unit correlated with the thus obtained printer type. Thereby, a storage capacity of the working storage unit of a printer can be obtained by obtaining the type of printer.

In addition, in the image print instruction apparatus of the present invention, it is also possible that the image resizing module resizes images with a tendency to make an image which is greater in size on the print layout among respective images arranged on the print layout greater in image size after resizing. Thereby, an image which is greater in size on a print layout can be made greater in image size after resizing. As a result, the respective images arranged on the print layout can be made more uniform in print quality.

Furthermore, in the image print instruction apparatus of the present invention, it is also possible that the image resizing module judges an amount of allocation of the predetermined data volume to respective images arranged on the print layout and resizes the images based on the judged amount of allocation. Thereby, the amount of allocation to respective images can be judged and the images can be resized. In this case, it is also possible that the information storage unit stores templates each having at least one image frame for which an allocation rate of the predetermined data volume has been set for each of the image frames, the print layout setting module sets a print layout by arranging images in respective image frames of a template selected from the templates stored in the information storage unit, and the image resizing module judges the amount of allocation for an image arranged in the image frame based on an allocation rate set for the image frame. Thereby, a print layout can be set by use of a template while the amount of allocation can be judged according to the allocation rate of an image frame, for carrying out image resizing. As a result, a process for setting a print layout and a process for judging the amount of allocation can be further simplified. In addition, the information storage unit stores the amount of allocation and image sizes in a correlated manner, and the image resizing module resizes the images so as to have image sizes correlated with the judged amount of allocation. Thereby, since only resizing to an image size correlated with the amount of allocation is sufficient, a process for resizing an image can be further simplified.

Alternatively, in the image print instruction apparatus of the present invention, it is also possible that the print layout setting module is capable of arranging images with a rotation of the images, and the image resizing module resizes images arranged with a rotation by the print layout setting module with a rotation. Thereby, when an arrangement involves a rotation of images on a print layout, the images can be rotated in advance and then transmitted to the printer. As a result, a process burden at the printer side can be further reduced.

In the image print instruction apparatus of the present invention, it is also possible that the image resizing module is for making the information storage unit store resized images, and the print instructing module instructs the printer, by transmitting location information on resized images in the information storage unit and information concerning the print layout, to print resized images according to the print layout. Thereby, a print instruction can be given to the printer by transmitting location information on resized images and information concerning a print layout. In this case, it is also possible that the information storage unit stores a dummy file having a data volume more than the predetermined data volume, and the image resizing module deletes the dummy file and makes the information storage unit store the resized images when the resized images cannot be stored owing to an insufficiency in available capacity of the information storage unit. Thereby, a resized image writing error owing to an insufficiency in available capacity of the information storage means can be prevented.

In the image print instruction apparatus of the present invention, it is also possible that the image print instruction apparatus is a digital camera having a photographic work memory used when carrying out photography, the image resizing module is for making the work memory store resized images, and the print instructing module instructs the printer, by transmitting resized images stored in the work memory and information concerning the print layout, to print the resized images according to the print layout. Thereby, resized images can be stored by use of a photographic work memory of a digital camera, and a print instruction can be given to the printer by swiftly transmitting the resized images and information concerning a print layout even if there is no available capacity in the information storage unit.

The present invention is also directed to a control method of an image print instruction apparatus including an information storage unit for storing images and instructing a communicable printer to print images. The control method of the image print instruction apparatus including the steps of: (a) obtaining a storage capacity of a working storage unit possessed by the printer; (b) setting a print layout by arranging at least one of the images stored in the information storage unit; (c) resizing images so that a total amount of data volumes of respective images arranged on the print layout becomes within a predetermined data volume on the basis of the storage capacity of the working storage unit; and (d) instructing the printer to print the resized images according to the print layout.

In this control method of an image print instruction apparatus of the present invention, a storage capacity of the working storage unit of the printer is obtained, while respective images are resized so that a total amount of data volumes of the respective images arranged on a print layout becomes within a predetermined data volume on the basis of the storage capacity of the working storage unit, and the printer is instructed to print the resized images. Accordingly, the total amount of data volumes of the respective images to be transmitted to the printer can be made within the predetermined data volume on the basis of the storage capacity of the working storage unit of the printer. As a result, image printing can be more appropriately instructed according to the storage capacity of the working storage unit of the printer while processing efficiency of various image processes at the printer side can be improved. Herein, the “image print instruction apparatus” may be digital camera.

The present invention is also directed to a storage medium for storing a program used for an image print instruction apparatus including an information storage unit for storing images and instructing a communicable printer to print images. And the program includes: a storage capacity obtaining module for obtaining a storage capacity of a working storage unit possessed by the printer; a print layout setting module for setting a print layout by arranging at least one of the images stored in the information storage unit; an image resizing module for resizing images so that a total amount of data volumes of respective images arranged on the print layout becomes within a predetermined data volume on the basis of the storage capacity of the working storage unit; and a print instructing module for instructing the printer to print the resized images according to the print layout.

This storage medium of the present invention makes, by installing a program in an image print instruction apparatus and running the same, the image print instruction apparatus function as an apparatus for obtaining a storage capacity of the working storage unit of the printer while resizing respective images so that a total amount of data volumes of the respective images arranged on a print layout becomes within a predetermined data volume on the basis of the storage capacity of the working storage unit and instructing the printer to print the resized images. Accordingly, the total amount of data volumes of the respective images to be transmitted to the printer can be made within the predetermined data volume on the basis of the storage capacity of the working storage unit of the printer. As a result, image printing can be more appropriately instructed according to the storage capacity of the working storage unit of the printer while processing efficiency of various image processes at the printer side can be improved. Herein, the “image print instruction apparatus” can be a digital camera.

The present invention is also directed to an image printing system including a printer and an image print instruction apparatus for instructing the printer to print images. The image print instruction apparatus includes: an information storage unit for storing images; a print layout setting module for setting a print layout by arranging at least one of the images stored in the information storage unit; and a print instructing module for instructing the printer to print images arranged on the print layout according to the print layout. And the printer includes: a working storage unit for temporarily storing data; an image size setting module for setting image sizes of images after resizing so that a total amount of data volumes of respective images arranged on the print layout for which printing has been instructed by the image print instruction apparatus becomes within a predetermined data volume on the basis of a storage capacity of the working storage unit; a resizing instructing module for instructing the image print instruction apparatus on resizing to the set image sizes; and a print executing module for obtaining images resized by the image print instruction apparatus in accordance with the instruction and executing printing of the images according to the print layout.

In this image printing system of the present invention, by the image print instruction apparatus, a print layout is set and the printer is instructed on printing, and in the printer, image sizes of respective images after resizing are set so that a total amount of data volumes of the respective images arranged on a print layout becomes within a predetermined data volume on the basis of a storage capacity of the working storage means while the image print instruction apparatus is instructed on resizing to the set image sizes, and images resized in accordance with this instruction are obtained from the image print instruction apparatus, for executing printing. Accordingly, the total amount of data volumes of the respective images to be transmitted to the printer can be made within the predetermined data volume on the basis of the storage capacity of the working storage means of the printer. As a result, image printing can be more appropriately instructed according to the storage capacity of the working storage means of the printer while processing efficiency of various image processes at the printer side can be improved.

### BRIEF DESCRIPTION OF THE DRAWINGS

FIG. 1 is an external appearance view showing an external appearance of a digital camera 20;

FIG. 2 is a rear view showing the rear surface of a digital camera 20;

FIG. 3 is a block diagram showing functional blocks of a digital camera 20;

FIG. 4 is a flowchart showing an example of a layout print process;

FIG. 5 is an explanatory view showing an example of a print menu screen;

FIG. 6 is an explanatory view showing an example of a layout print template selection screen;

FIG. 7 is an explanatory view showing an example of an image selection screen;

FIG. 8 is an explanatory view showing an example of a print setting confirmation screen;

FIG. 9 is an explanatory view showing examples of allocation rates preset for respective image frames of a template;

FIG. 10 is an explanatory view showing an example of an image size derivation table;

FIG. 11 is an explanatory view showing an example of print layout information;

FIG. 12 is a flowchart showing processes in an image forming system of a modification.

### DESCRIPTION OF THE PREFERRED EMBODIMENT

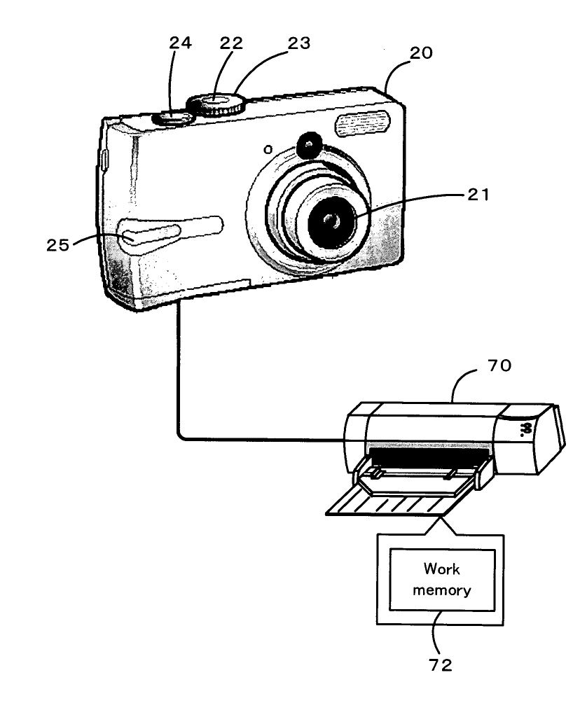

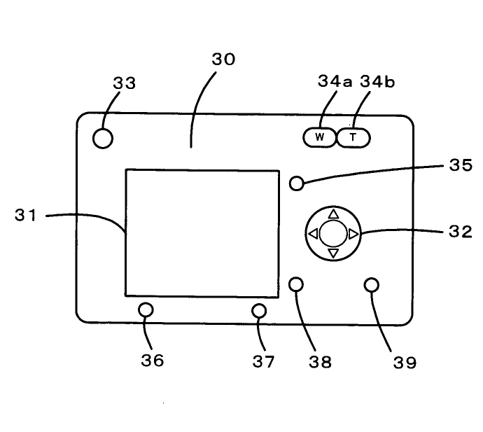

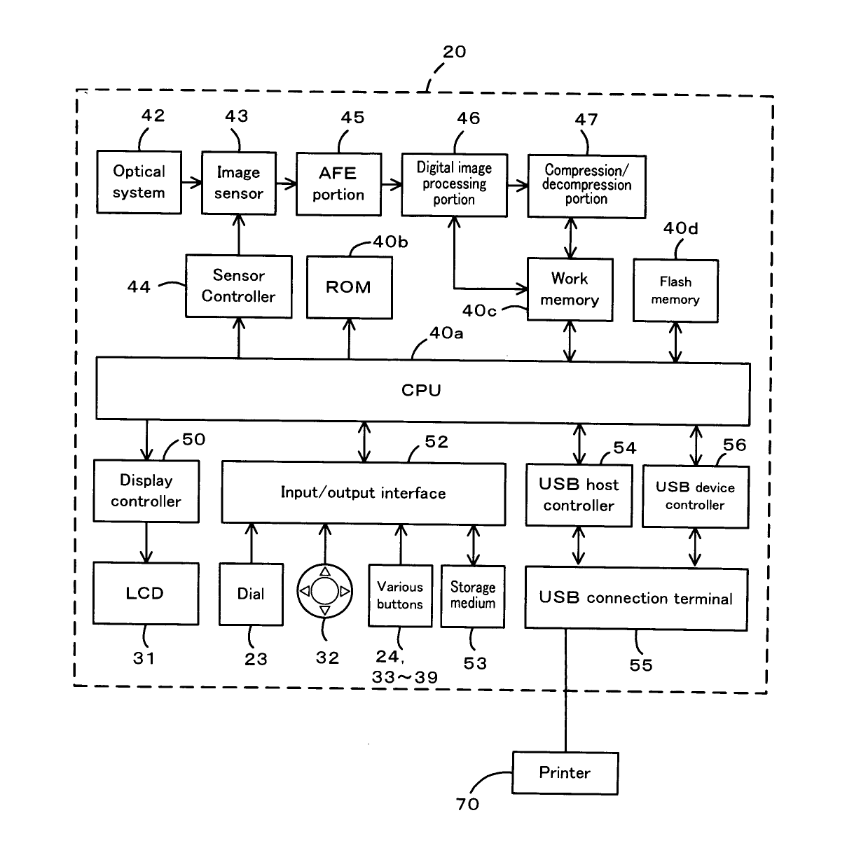

Next, a preferred embodiment of the present invention will be described. FIG. 1 is an external appearance view showing an external appearance of a digital camera 20 which functions as an image print instruction apparatus being an embodiment of the present invention, FIG. 2 is a rear view showing the rear surface of a digital camera 20, and FIG. 3 is a block diagram showing functional blocks of a digital camera 20.

The digital camera 20 of the embodiment is, as shown in FIG. 1, provided with, at the front, a lens 21 with a zoom mechanism capable of optical 3 times zooming and a self-timer lighting portion 25 for indicating that a self-timer is operating by flashing, and, at the top, a mode dial 23 for selecting a mode, a power button 22 arranged at the center of this mode dial 23, and a shutter button 24, and instructs a printer 70 connected via a communication cable such as a USB cable to print a photographed image. In addition, on a rear surface 30 of the digital camera 20, provided are, as shown in FIG. 2, a liquid crystal display 31 arranged in the center nearer to the left, a 4-direction button 32 which is arranged on the right side of the same and can be operated in the up-and-down and right and left directions, a print button 33 arranged at the upper left of the rear surface 30, a W-button 34a and a T-button 34b for operating the zoom mechanism, a menu button 35 arranged at the upper left of the 4-direction button 32, an A button 36 and a.B button 37 arranged at the left and right below the liquid crystal display 31, a display button 38 arranged at the left below the 4-direction button 32, for switching a display on the liquid crystal display 31, and a review button 39 arranged rightward with respect to the same.

The digital camera 20 of the embodiment is functionally, as is exemplified in FIG. 3, composed mainly of a CPU 40a as a central processing unit, a ROM 40b for storing processing programs and the like, a work memory 40c for temporarily storing data, and a flash memory 40d for storing set data non-volatilely. The digital camera 20 is provided with, as a photography system, an optical system 42 comprising lenses and diaphragms, an image sensor 43 for accumulating an electrical charge obtained by a photoelectric conversion of an optical image formed by this optical system 42 for a fixed period of time in each light-receiving cell and outputting an electrical signal according to the amount of received light of each light receiving cell, a sensor controller 44 as a drive circuit for outputting a drive pulse necessary for driving this image sensor 43 to the image sensor 43, an analog front end (AFE) portion 45 for quantizing an electrical signal outputted from the image sensor 43 and converting the same to a digital signal, a digital image processing portion 46 for applying, to a digital signal outputted from this AFE portion 45, an image forming process, a white-balance correction, a y-correction, a color space conversion and the like so as to output a digital image showing gradient values of R, G, and B and gradient values of Y, Cb, and Cr with regard to each pixel, and a compression/decompression portion 47 for compressing a digital image by carrying out a sequence transformation (such as a discrete cosine transformation or a wavelet transformation) of a digital image and entropy coding (such as run-length encoding or Huffman coding) of a digital image as well as for decompressing a digital image by applying inverse transformations of these. In addition, the digital camera 20 of the embodiment is also provided with a display controller 50 having on a frame buffer for storing data for one-screen of the liquid crystal display 31 and a display circuit for driving the liquid crystal display 31 based on a digital image stored in the frame buffer, an input/output interface 52 for controlling inputs of the mode dial 23, 4-direction button 32, various buttons 24 and 33 to 39 and an input and output into and from a storage medium 53, and a USB host controller 54 and USB device controller 56 for administering communication correspondences with a device (computer or printer) connected to a USB connection terminal 55. Here, image data image-processed by the digital image processing portion 46 and image data compressed/decompressed by the compression/decompression portion 47 are once written into the work memory 40c, and then are written into the storage medium 53 via the input/output interface 52 as image files with file names given in order of shooting.

The printer 70 is constructed as a general ink-jet printer, and applies various image processes (such as a color conversion process and a binarization process) , by means of a work memory 72, to an image transmitted from the digital camera 20, an image which has been stored in a memory card inserted in an unillustrated card slot or the like so as to generate printing data and executes printing based on the generated printing data.

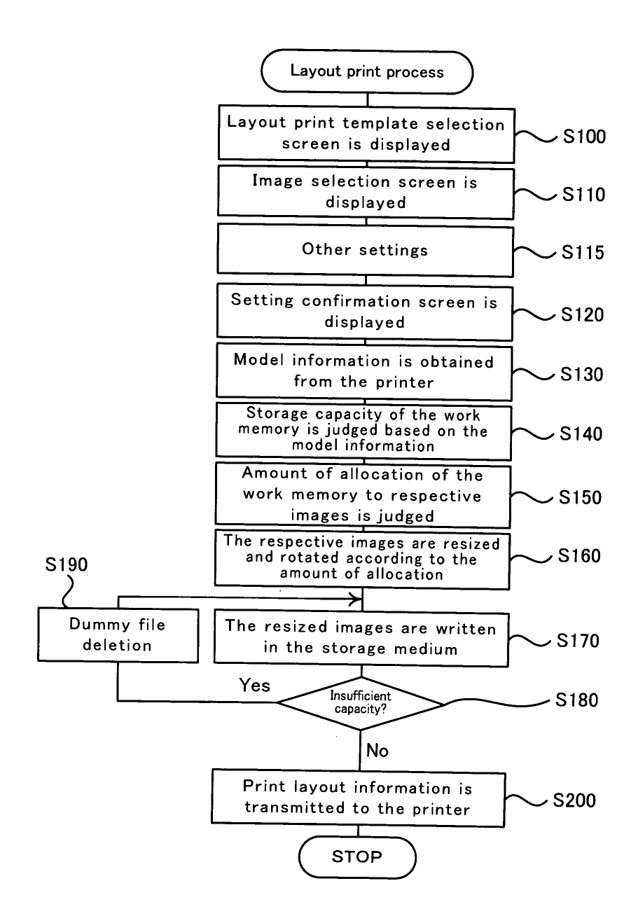

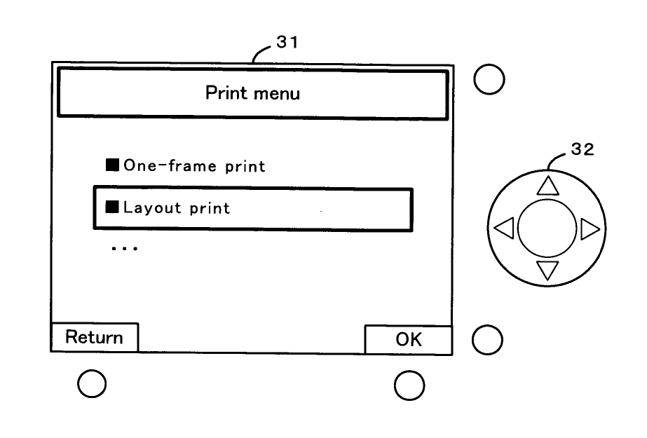

Next, operations of the digital camera 20 of the embodiment constructed as such, in particular, operations when instructing the printer 70 to print a photographed image will be described. In the embodiment, description will be given for a case where layout print for laying out a plurality of images on a sheet of paper and printing the same is carried out as a concrete example. FIG. 4 is a flowchart showing an example of a layout print process executed by the CPU 40a when layout print is instructed by a user. In the embodiment, an instruction of layout print is carried out when a “layout print” is selected via a print menu screen (see FIG. 5) displayed on the liquid crystal display 31 when the print button 33 is pushed in a condition where the mode dial 23 has been aligned to a “reproduction mode.”

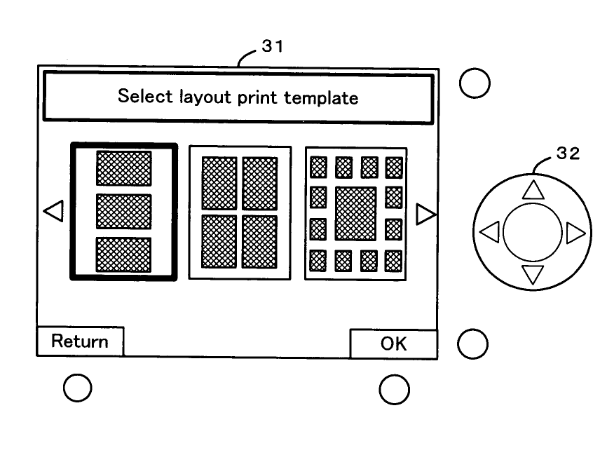

In the layout print process, first, as illustrated, a layout print template selection screen for selecting a template having image frames in which printing images are laid out is displayed on the liquid crystal display 31 (step S100). FIG. 6 is an explanatory view showing an example of the liquid crystal display 31 on which a layout print template selection screen has been displayed. The layout print template selection screen is constructed, as illustrated, so as to selectably display a plurality of templates stored in the ROM 40b or the like in advance. The user selects a desirable template by pointing the cursor by operating the 4-direction button 32 leftward or rightward.

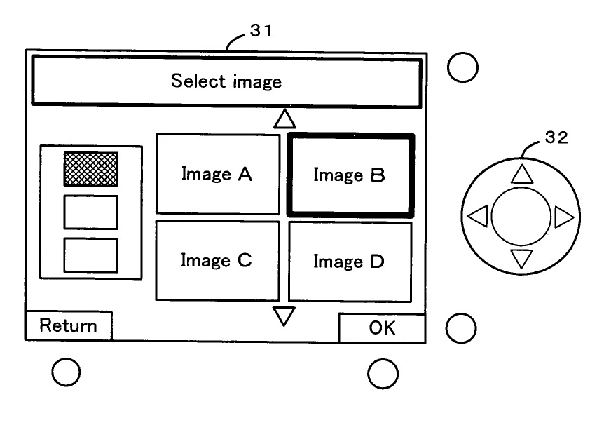

Subsequently, an image selection screen for selecting images to be arranged in respective image frames of a selected template is displayed on the liquid crystal display 31 (step S110). FIG. 7 is an explanatory view showing an example of the liquid crystal display 31 on which an image selection screen has been displayed. The image selection screen is constructed, as illustrated, so as to display a selected template on the left side of the screen and display a list of images stored in the storage medium 53 on the right side of the screen. The user selects images to be arranged in respective image frames of the selected template by operating the 4-direction button 32.

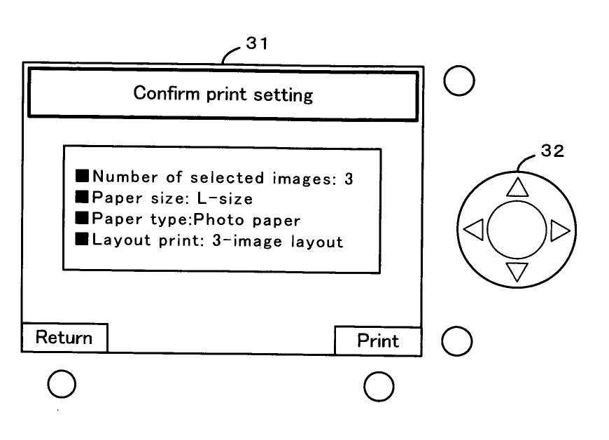

Then, when other settings concerning layout print (such as settings of a paper size and a paper type and the like) have been provided (step S115), a print setting confirmation screen exemplified in FIG. 8 is displayed on the liquid crystal display 31 (step S120), and when an instruction to start printing has been given via this print setting confirmation screen by the user, model information is obtained from the printer 70 (step S130). An obtainment of printer 70 model information is carried out by transmitting a command to request a transmission of model information to the printer 70.

Subsequently, a storage capacity of the work memory 72 of the printer 70 is judged based on the obtained printer 70 model information (step S140). In the embodiment, a storage capacity of the work memory 72 for each piece of printer 70 model information is stored in the flash memory 40d or the like in advance, and a storage capacity of the work memory 72 corresponding to the obtained model information is read-in from the flash memory 40d or the like.

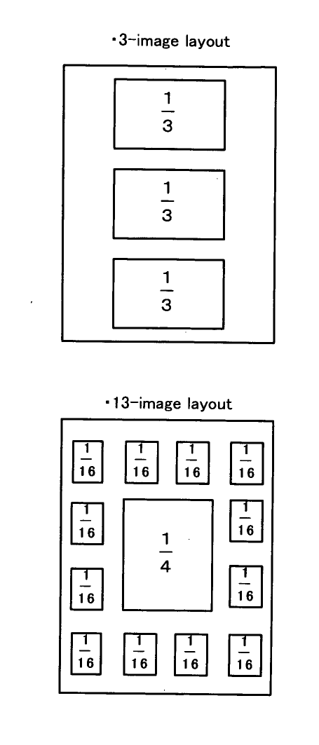

When a storage capacity of the work memory 72 of the printer 70 has judged as such, the amount of allocation of the work memory 72 to images arranged in the respective image frames is judged (step S150). Concretely, the amount of allocation calculated by multiplying an allocation rate preset for each image frame of the template selected in step S100 and a storage capacity of the work memory 72 together is judged as an amount of allocation to an image arranged in that image frame. FIG. 9 is an explanatory view showing examples of allocation rates preset for respective image frames of a template. As illustrated, for example, in a 3-image layout template, the allocation rate of each image frame is set at ⅓, and in a 13-image layout template, the allocation rate of an image frame arranged at the center, which is larger than other image frames, has been set at ¼ while the allocation rates of the other image frames have been set at 1/16. As such, storage capacity of the work memory 72 is allocated to the respective image frames according to sizes of the image frames.

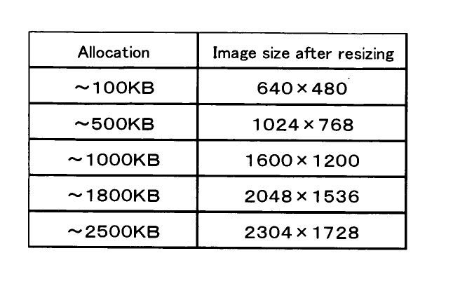

Subsequently, respective images are resized based on the judged amount of allocation, while for images to be arranged with a rotation, an image rotation is carried out (step S160). For resizing of the respective images, in the embodiment, a relationship between the amount of allocation and image sizes after resizing is determined in advance and stored in the ROM 40b or the like as an image size derivation table, and then the respective images are resized so as to have image sizes derived by use of this image size derivation table. In an image size derivation table exemplified in FIG. 10, image sizes after resizing have been set for ranges of the amount of allocation. Concretely, by determining a relationship between the image data volume and image size by experiment or the like, image sizes to provide data volumes within the amount of allocation are set.

When the respective images have resized as such, the resized images are written in the storage medium 53 (step S170). At this time, when the image writing is impossible owing to an insufficiency in available capacity of the storage medium 53, the images are written after deletion of a dummy file stored in advance in the storage medium 53 (steps S180 and S190). This dummy file has been preset as a file larger than the maximum storage capacity among memory capacities of work memories 72 of printers 70 with which the digital camera 20 is compatible, and has been written in the storage medium 53 at a predetermined timing (such as a timing where the digital camera 20 is powered on).

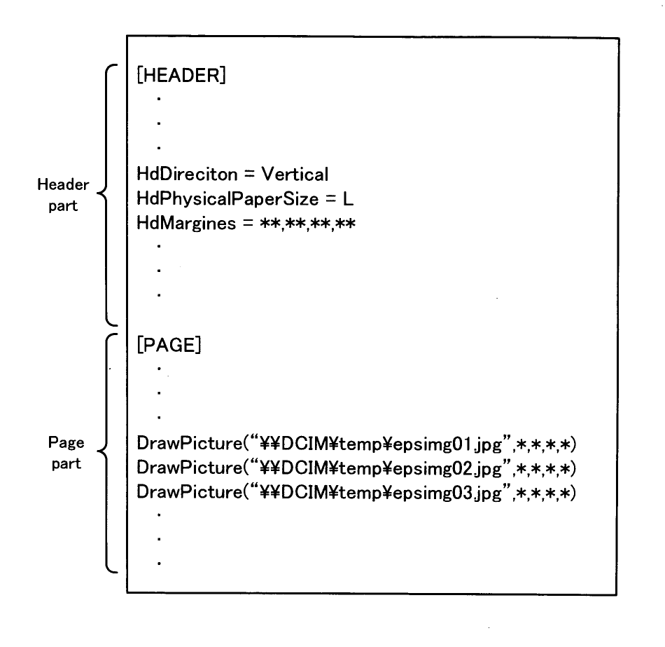

Then, print layout information describing respective pieces of setting information concerning printing is transmitted to the printer 70 (step S200), and this layout print process is finished. FIG. 11 is an explanatory view showing an example of print layout information to be transmitted to the printer 70. The print layout information is composed of a header portion in which basic information concerning printing such as a paper size, a paper direction, and a margin size has been described and a page portion in which information concerning the contents of printing such as images to be printed, wherein file names of resized images written in the storage medium 53 have been described in the page portion. In the printer 70 which has received the print layout information, resized images are received from the digital camera 20 based on the file names described in the page portion, and various image processes are applied to these received images by use of the work memory 72 to generate printing data so as to execute printing. In this case, since the received images have been resized according to the amount of allocation of the work memory 72, a decline i n processing efficiency owing to an insufficiency in capacity of the work memory 72 can be prevented.

According to the digital camera 20 of the embodiment described in the above, a storage capacity of the work memory 72 of the printer 70 is judged by obtaining model information of the printer 70 and the amount of allocation of the work memory 72 to the respective images arranged in image frames of a template is judged, and the respective images are resized based on this amount of allocation so that printing can be instructed. Namely, it is possible to provide the total amount of data volumes of respective images to be transmitted to the printer 70 within the storage capacity of the work memory 72. As a result, image printing can be more appropriately instructed according to the storage capacity of the work memory 72 and processing efficiency of various image processes at the printer 70 side can be improved. In addition, since the storage capacity of the work memory 72 is allocated according to the sizes of the respective image frames, the respective images can be made more uniform in print quality. Furthermore, for images to be arranged in the image frames with a rotation, since the images are resized and rotated, a process burden at the printer 70 side can be further reduced.

In addition, according to the digital camera 20 of the embodiment, since the amount of allocation for images arranged in the respective image frames is judged by multiplying an allocation rate preset for each image frame of a template and a storage capacity of the work memory 72 together, the process for judging the amount of allocation can be further simplified. Furthermore, since the respective images are resized so as to have image sizes derived by use of an image size derivation table for managing a relationship between the amount of allocation and image sizes after resizing, the process for resizing images can be further simplified. In addition, since images are written after deletion of a dummy file when image writing of resized images is impossible owing to an insufficiency in available capacity of the storage medium 53, an image writing error owing to an insufficiency in available capacity of the storage medium 53 can be prevented.

Herein, in the digital camera 20 of the embodiment, the ROM 40b, flash memory 40d, storage medium 53 and the like are equivalent to an information storage means, the CPU 40a for executing the processes of steps S100 to S120 is equivalent to a print layout setting means, the CPU 40a for executing the processes of steps S150 and S160 is equivalent to an image resizing means, the CPU 40a for executing the processes of steps S130 and S140 is equivalent to a storage capacity obtaining means, and the CPU 40a for executing the processes of steps S170 to S200 is equivalent to a print instructing means. In addition, the work memory 72 of the printer 70 is equivalent to a working storage means.

In the digital camera 20 of the embodiment, it has been described that a storage capacity of the work memory 72 of the printer 70 is judged based on model information of the printer 70, however, as long as storage capacity of the work memory 72 can be obtained, any method can be employed for the same. For example, storage capacity of the work memory 72 can be directly obtained from the printer 70. In addition, a fixed storage capacity may be used as a storage capacity of the work memory 72 regardless of the models of printer 70. In this case, it is sufficient to use the minimum storage capacity among memory capacities of work memories 72 of printers 70 with which the digital camera 20 is compatible.

In the digital camera 20 of the embodiment, it has been described that storage capacity of the work memory 72 is allocated to respective image frames according to sizes of the image frames, however, a criterion other than the sizes of image frames (such as positions of image frames, for example) can also be used to judge the amount of allocation of the work memory 72. In this case, it is sufficient to preset allocation rates for respective image frames of a template in accordance with the applied criterion. In addition, regardless of the sizes of image frames, storage capacity may be allocated equally to the respective image frames.

In the digital camera 20 of the embodiment, it has been described that the amount of allocation of the work memory 72 to respective images is judged, and the respective images are resized based on the judged amount of allocation, however, it is satisfactory as long as respective images can be resized so that the total amount of data volumes of the respective images becomes within the storage capacity of the work memory 72, and for example, a process for resizing respective images at an appropriate reduction rate canal so be repeatedly executed until the total amount of data volumes of the respective images becomes within the storage capacity of the work memory 72.

In the digital camera 20 of the embodiment, the total amount of data volumes of respective images has been provided within the storage capacity of the work memory 72 by resizing the respective images according to the amount of allocation of the work memory 72, however, it does not always have to be within the storage capacity, and it is sufficient to provide the same within a predetermined data volume on the basis of the storage capacity. For example, the amount of allocation for respective images may be judged so as to become within capacities equivalent to 80%, 90%, and 110% of the memory capacity of the work memory 72, for resizing.

In the digital camera 20 of the embodiment, it has been described that images are arranged in the respective image frames of a template, however, no such template may be used. For example, it may also be possible to arrange images at desirable positions and desirable sizes as a print layout. In this case, it is sufficient to judge the amount of allocation of the work memory 72 to respective arranged images based on the positions and sizes of the arranged images. In addition, although a description has been given for a case where layout print for laying out a plurality of images on a sheet of paper and printing the same is carried out as a concrete example, as a matter of course, without a limitation to such layout print, the present invention can be applied to a case where a sole image is used for printing as well.

In the digital camera 20 of the embodiment, it has been described that image sizes after resizing are derived by use of an image size derivation table for managing a relationship between the amount of allocation and image sizes after resizing, however, it is satisfactory as long as images can be resized according to the amount of allocation, and for example, the image sizes can also be calculated and determined based on the amount of allocation by use of an appropriate calculation formula.

In the digital camera 20 of the embodiment, it has been described that, for images to be arranged in image frames with a rotation, the images are resized and rotated, however, such an image rotation may not be carried out.

In the digital camera 20 of the embodiment, it has been described that, when writing of resized images is impossible owing to an insufficiency in available capacity of the storage medium 53, the images are written after deletion of a dummy file, however, such a dummy file may not be used. In addition, although it has been described that resized images are written in the storage medium 53 while print layout information describing file names of the written images is transmitted to the printer 70 so as to instruct printing, a print instruction does not always have to be carried out by such a method, and for example, the resized images may also be transmitted, without being written in the storage medium 53, directly to the printer 70.

In the digital camera 20 of the embodiment, it has been described that resized images are written in the storage medium 53, and print layout information describing file names of the written images is transmitted to the printer 70 so as to instruct printing, however, since the work memory 40c that is used for photography of the digital camera 20 is not being used when a print instruction is given by the digital camera 20, the resized images can also be written in this work memory 40c so that print layout information describing file names of the images written in this work memory 40c is transmitted so as to instruct printing. In this case, for the print layout information, since it is sufficient that the images written in the work memory 40c can be specified, it is unnecessary that file names of the images written in the work memory 40c have been described, and the print layout information can also be one having information (such as image numbers, for example) for specifying images written in the work memory 40c. In these cases, it is possible to write resized images so as to instruct printing, irrespective of the available capacity of the storage medium 53.

In the embodiment, a description has been given of the contents of the present invention that respective images are resized so that the total amount of data volumes of respective images to be transmitted to the printer 70 becomes within the storage capacity of the work memory 72 being a digital camera 20, however, as a matter of course, the invention can be applied to other various types of devices (such as a personal computer, a scanner, a television, and a projector) as long as it is an image print instruction apparatus for instructing a communicable printer to print images. In addition, the invention can be in a mode of a control method of such an image print instruction apparatus or in a mode of a program used in a manner installed in an image print instruction apparatus. In a case of the program mode, it is sufficient to program the respective steps of layout print processes exemplified in FIG. 4 by use of an appropriate programming language.

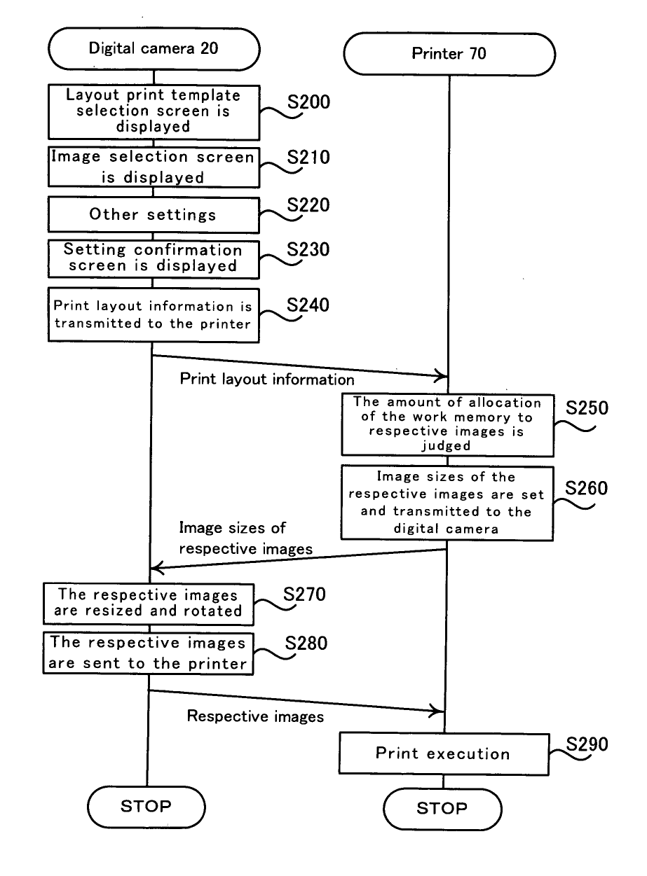

In the embodiment, although it has been described that a storage capacity of the work memory 72 of the printer 70 is judged while the amount of allocation to respective images is judged by the digital camera 20, the invention can also be in a mode of an image printing system for carrying out such a process at the printer 70 side. Namely, as exemplified in FIG. 12, the invention can also be in a mode of an image printing system for: carrying out various settings such as a template selection and an image arrangement and transmitting print layout information to the printer 70 at the digital camera side 20 (steps S200 to S240) ; at the printer 70 which has received the print layout information, judging the amount of allocation of the work memory 72 to respective images based on the received print layout information (such as sizes of respective image frames) so as to set image sizes after resizing while instructing the digital camera 20 to carry out resizing to the set image sizes and a rotation (steps S250 and S260), and receiving, at the printer 70 side, images resized and rotated at the digital camera 20 side in accordance with this instruction and executing printing (steps S270 to S290).

While a description has been given in the above of the best mode for carrying out the invention by use of an embodiment, the present invention is by no means limited to such an embodiment, and as a matter of course, it can be carried out in various modes without departing from the gist of the invention.

In this specification, all the contents of the specifications, drawings, and claims disclosed respectively in Japanese Patent Application No. 2004-213220 filed on Jul. 21, 2004 and Japanese Patent Application No. 2005-206737 filed on Jul. 15, 2005 are hereby incorporated by reference.

What is claimed is:

1. An image print instruction apparatus for instructing a communicable printer to print images, comprising:
an information storage unit for storing images;
a storage capacity obtaining module for obtaining a storage capacity of a working storage unit possessed by the printer;
a print layout setting module for setting a print layout by arranging at least one of the images stored in the information storage unit;
an image resizing module for resizing images so that a total amount of data volumes of respective images arranged on the print layout becomes within a predetermined data volume on the basis of the storage capacity of the working storage unit; and
a print instructing module for instructing the printer to print the resized images according to the print layout.

2. An image print instruction apparatus in accordance with in claim 1, wherein
the information storage unit stores types of printers and storage capacities of working storage units possessed by the printers in a correlated manner, and
the storage capacity obtaining module obtains, from the printer, the type of printer and obtains, from the information storage unit, a storage capacity of a working storage unit correlated with the obtained printer type.

3. An image print instruction apparatus in accordance with in claim 1, wherein
the image resizing module resizes images with a tendency to make an image which is greater in size on the print layout among respective images arranged on the print layout greater in image size after resizing.

4. An image print instruction apparatus in accordance with in claim 1, wherein
the image resizing module judges an amount of allocation of the predetermined data volume to respective images arranged on the print layout and resizes the images based on the judged amount of allocation.

5. An image print instruction apparatus in accordance with in claim 4, wherein
the information storage unit stores templates each having at least one image frame for which an allocation rate of the predetermined data volume has been set for each of the image frames,
the print layout setting module sets a print layout by arranging images in respective image frames of a template selected from the templates stored in the information storage unit, and
the image resizing module judges the amount of allocation for an image arranged in the image frame based on an allocation rate set for the image frame.

6. An image print instruction apparatus in accordance with in claim 4, wherein
the information storage unit stores the amount of allocation and image sizes in a correlated manner, and
the image resizing module resizes the images so as to have image sizes correlated with the judged amount of allocation.

7. An image print instruction apparatus in accordance with in claim 1, wherein
the print layout setting module is capable of arranging images with a rotation of the images, and
the image resizing module resizes images arranged with a rotation by the print layout setting module with a rotation.

8. An image print instruction apparatus in accordance with in claim 1, wherein
the image resizing module is for making the information storage unit store resized images, and
the print instructing module instructs the printer, by transmitting location information on resized images in the information storage unit and information concerning the print layout, to print resized images according to the print layout.

9. An image print instruction apparatus in accordance with in claim 8, wherein
the information storage unit stores a dummy file having a data volume more than the predetermined data volume, and
the image resizing module deletes the dummy file and makes the information storage unit store the resized images when the resized images cannot be stored owing to an insufficiency in available capacity of the information storage unit.

10. An image print instruction apparatus in accordance with in claim 1, the image print instruction apparatus is a digital camera.

11. An image print instruction apparatus in accordance with in claim 1, the image print instruction apparatus is a digital camera having a photographic work memory used when carrying out photography, wherein
the image resizing module is for making the work memory store resized images, and
the print instructing module instructs the printer, by transmitting resized images stored in the work memory and information concerning the print layout, to print the resized images according to the print layout.

12. A control method of an image print instruction apparatus comprising an information storage unit for storing images, for instructing a communicable printer to print images, comprising the steps of:
(a) obtaining a storage capacity of a working storage unit possessed by the printer;
(b) setting a print layout by arranging at least one of the images stored in the information storage unit;
(c) resizing images so that a total amount of data volumes of respective images arranged on the print layout becomes within a predetermined data volume on the basis of the storage capacity of the working storage unit; and
(d) instructing the printer to print the resized images according to the print layout.

13. A storage medium for storing a program used for an image print instruction apparatus comprising an information storage unit for storing images, for instructing a communicable printer to print images, wherein
the program comprises: a storage capacity obtaining module for obtaining a storage capacity of a working storage unit possessed by the printer; a print layout setting module for setting a print layout by arranging at least one of the images stored in the information storage unit; an image resizing module for resizing images so that a total amount of data volumes of respective images arranged on the print layout becomes within a predetermined data volume on the basis of the storage capacity of the working storage unit; and a print instructing module for instructing the printer to print the resized images according to the print layout.

14. An image printing system comprising a printer and an image print instruction apparatus for instructing the printer to print images, wherein
the image print instruction apparatus comprises: an information storage unit for storing images; a print layout setting module for setting a print layout by arranging at least one of the images stored in the information storage unit; and a print instructing module for instructing the printer to print images arranged on the print layout according to the print layout, and
the printer comprises: a working storage unit for temporarily storing data; an image size setting module for setting image sizes of images after resizing so that a total amount of data volumes of respective images arranged on the print layout for which printing has been instructed by the image print instruction apparatus becomes within a predetermined data volume on the basis of a storage capacity of the working storage unit; a resizing instructing module for instructing the image print instruction apparatus on resizing to the set image sizes; and a print executing module for obtaining images resized by the image print instruction apparatus in accordance with the instruction and executing printing of the images according to the print layout.
